(19) United States
(12) Patent Application Publication
(10) Pub. No.: US 2026/0010899 A1
(43) Pub. Date: Jan. 8, 2026

(54) SYSTEMS AND METHODS TO IDENTIFY FRICTION EVENTS DURING AN ELECTRONIC JOURNEY OF A CUSTOMER OF A BUSINESS

(71) Applicant: TEACHERS INSURANCE AND ANNUITY ASSOCIATION OF AMERICA, New Tork, NY (US)

(72) Inventors: Shafiq Kassam, Lewisville, TX (US); Scott Andrew Lutz, Lewisville, TX (US); Sampada Sanjay Salunkhe, Acton, MA (US); LeeAnn Marie Flanagan Beary, Medway, MA (US); Siva Subramanian Sankaravel, Frisco, TX (US); Igor Tomashevskiy, Old Bridge, NJ (US); Benakesh Hosamane, Belle Mead, NJ (US); Ajit I. Naidu, Wyckoff, NJ (US)

(21) Appl. No.: 18/765,022

(22) Filed: Jul. 5, 2024

(51) Int. Cl. G06Q 20/38; G06Q 20/40

(52) U.S. Cl. CPC G06Q 20/389; G06Q 20/405

(57) ABSTRACT

System and methods to identify one or more friction events during an electronic journey of a customer of a business are disclosed. The system obtains a plurality of electronic customer journey datasets. At least one electronic customer journey dataset corresponds to the electronic journey of the customer during a transaction between the customer and the business, and indicates associated transactional events. The system uses friction identification rules to identify the friction events indicated in the electronic customer journey datasets that negatively impact completion of the transaction. Responsive to identifying the friction event, the system generates friction event information, and provides the friction event information to a fine-tuned large language model (LLM). The fine-tuned LLM determines topics and customer sentiments associated with the friction event. The system generates a user interface including the friction event information, and/or an electronic alert based upon the friction event information.

### FIELD OF THE INVENTION

The present disclosure generally relates to friction events, and more particularly, systems and methods to identify one or more friction events during an electronic journey of a customer of a business.

### BACKGROUND

A transaction between a business and a customer may include one or more transactional events or interactions which are electronic in nature. In one example, opening a new retirement account may include the customer providing information via an electronic form, and the retirement service provider creating an electronic customer profile in a database and generating user credentials for online account management. In another example, although the customer may have a non-electronic interaction with the business, such as receiving investment advice in-person, one or more electronic transactional events and/or electronic interactions may be involved in the overall transaction, such as using electronic devices to generate and process paperwork associated with a reallocation of retirement funds based upon the advice, conducting electronic transactions via an online retirement account portal to reallocate the funds, and the like. The experience of the customer while conducting a transaction with a business which includes one or more electronic transactional events and/or electronic interactions, referred to as an electronic customer journey, can be adversely affected by a friction event, i.e., an event that negatively impacts completion of the transaction between the business and the customer. Unfortunately, many businesses face challenges in identifying friction events before, or as, they occur, leading to delays and inefficiencies associated with conducting transactions.

Traditional systems struggle with identifying and aggregating electronic customer journey information of customer interactions with a business that provide insight into the customer experience, as such as information is received through various channels and mediums, e.g., websites, mobile applications, email, telephone calls, etc. This can lead to a business collecting fragmented and/or outdated information associated with the electronic customer journey. Moreover, without a meaningful analysis of the electronic customer journey information to identify and understand the causes and characteristics of friction events during electronic customer journeys, the business will be unable to transition from reactively addressing friction events, to proactively mitigating, or avoiding altogether, future friction events. The inability of the business to quickly gather and analyze the various types of information and data that provide a comprehensive view of the electronic customer journey and associated friction events, leads to missed opportunities to improve the quality of business services when otherwise reducing/eliminating friction, improve the operation of business systems which may cause or contribute to the friction, improve customer satisfaction as a result of such improvements, among other things. The conventional techniques for identifying friction events during the electronic customer journey may include additional ineffectiveness, inefficiencies, encumbrances, and/or other drawbacks.

Accordingly, there is a need for improved systems and methods to identify one or more friction events during the electronic journey of the customer of the business, as described herein.

### BRIEF SUMMARY OF THE INVENTION

The present embodiments relate to, inter alia, systems and methods to identify one or more friction events during an electronic journey of a customer of a business.

In one aspect, a system to identify one or more friction events during an electronic journey of a customer of a business includes one or more processors; and one or more memories having stored thereon a set of computer-executable instructions that, when executed, cause the one or more processors to: (i) obtain, via the one or more processors, a plurality of electronic customer journey datasets, wherein at least one of the plurality of electronic customer journey datasets, corresponds to the electronic journey of the customer, corresponds to a transaction between the customer and the business, and indicates one or more transactional events associated with the transaction; (ii) obtain, via the one or more processors, friction identification rules used to identify the one or more friction events indicated in the at least one of the plurality of electronic customer journey datasets, wherein a friction event is an event that negatively impacts completion of the transaction; (iii) analyze, via the one or more processors, the at least one of the plurality of electronic customer journey datasets using the friction identification rules; (iv) responsive to identifying a friction event, generate, via the one or more processors, friction event information associated with the friction event; (v) provide, via the one or more processors, the friction event information to a fine-tuned large language model (LLM), stored on the one or more memories, and configured to: determine one or more topics associated with the friction event of the friction event information, determine one or more sentiments of the customer associated with the friction event of friction event information, and generate an indication, in the friction event information, of the one or more topics and/or the one or more sentiments; and (vi) generate, via the one or more processors, a user interface including the friction event information, wherein the user interface is accessible via a computing device, and/or an electronic alert based upon the friction event information.

In another aspect, a computer-implemented method to identify one or more friction events during an electronic journey of a customer of a business, the computer-implemented method includes: (i) obtaining, via one or more processors, a plurality of electronic customer journey datasets, wherein at least one of the plurality of electronic customer journey datasets, corresponds to the electronic journey of the customer, corresponds to a transaction between the customer and the business, and indicates one or more transactional events associated with the transaction; (ii) obtaining, via the one or more processors, friction identification rules used to identify the one or more friction events indicated in the at least one of the plurality of electronic customer journey datasets, wherein a friction event is an event that negatively impacts completion of the transaction; (iii) analyzing, via the one or more processors, the at least one of the plurality of electronic customer journey datasets using the friction identification rules; (iv) responsive to identifying a friction event, generating, via the one or more processors, friction event information associated with the friction event; (v) providing, via the one or more processors, the friction event information to a fine-tuned large language model (LLM) configured to: determine one or more topics associated with the friction event of the friction event information, determine one or more sentiments of the customer associated with the friction event of friction event information, and generate an indication, in the friction event information, of the one or more topics and/or the one or more sentiments; and (vi) generate, via the one or more processors, a user interface including the friction event information, wherein the user interface is accessible via a computing device, and/or an electronic alert based upon the friction event information.

In yet another aspect, a non-transitory computer-readable medium storing processor-executable instructions that, when executed by one or more processors, cause the one or more processors to at least: (i) obtain a plurality of electronic customer journey datasets, wherein at least one of the plurality of electronic customer journey datasets, corresponds to an electronic journey of a customer of a business, corresponds to a transaction between the customer and the business, and indicates one or more transactional events associated with the transaction; (ii) obtain friction identification rules used to identify one or more friction events indicated in the at least one of the plurality of electronic customer journey datasets, wherein a friction event is an event that negatively impacts completion of the transaction; (iii) analyze the at least one of the plurality of electronic customer journey datasets using the friction identification rules; (iv) responsive to identifying a friction event, generate friction event information associated with the friction event; (v) provide the friction event information to a fine-tuned large language model (LLM), stored on one or more memories, and configured to: determine one or more topics associated with the friction event of the friction event information, determine one or more sentiments of the customer associated with the friction event of friction event information, and generate an indication, in the friction event information, of the one or more topics and/or the one or more sentiments; and (vi) generate a user interface including the friction event information, wherein the user interface is accessible via a computing device, ands; or an electronic alert based upon the friction event information.

Additional, alternate and/or fewer actions, steps, features and/or functionality may be included in an aspect and/or embodiments, including those described elsewhere herein.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing environment to identify one or more friction events during an electronic journey of a customer of a business, according to one embodiment.

FIG. 2 depicts a data flow diagram for example training and operation of an ML model, according to one embodiment.

FIG. 3A depicts an example block diagram of a system for detecting friction during an electronic customer journey, according to one embodiment.

FIG. 3B depicts an example user interface for providing friction event information, according to one embodiment.

FIG. 4 depicts a flow diagram of an example computer-implemented method to identify one or more friction events during an electronic journey of a customer of a business, according to one embodiment.

FIG. 5A depicts a flow diagram of an example electronic customer journey workflow, according to some embodiments.

FIG. 5B depicts a flow diagram of example processing of a request in an automated straight through manner, and processing the request including manual intervention, according to some embodiments.

FIG. 5C depicts an example work flow for identifying friction and generating associated notifications, according to some embodiments.

FIG. 5D depicts an example flow of data used for identifying friction during an electronic customer journey, according to some embodiments.

FIG. 5E depicts an example flow of data for identifying friction during an electronic customer journey using voice of the customer survey data, according to some embodiments.

FIG. 5F depicts an example flow of data for identifying friction during an electronic customer journey using closed loop feedback, according to some embodiments.

FIG. 5G depicts an example flow of data for identifying friction during an electronic customer journey using structured learning, according to some embodiments.

FIG. 5H depicts an example flow of data for identifying friction during an electronic customer journey using structured learning, according to some embodiments.

### DETAILED DESCRIPTION

The computer systems and computer-implemented methods disclosed herein apply friction identification rules to electronic customer journeys datasets corresponding to the electronic customer journeys, to identify friction events during the electronic customer journeys, and generate friction event information corresponding thereto. The systems and methods apply a fine-tuned LLM to the friction event information, to determine associated friction event topics and customer sentiments which provide insights into the causation and characteristic of friction events. The system and methods can generate a user interface and/or electronic alerts based upon friction event information, to provide actionable information associated with the friction caused by business systems and methods during an electronic customer journey.

The disclosed techniques advantageously provide improvements in technologies to detect and address friction events during an electronic customer journey. Friction identification rules are configured (e.g., to be industry-specific) and used to identify friction events in electronic customer journey data. The LLM is fine-tuned to understand industry-specific language in the friction event information, to accurately determine topics and customer sentiments associated with friction events. The valuable information and insights into the electronic customer journey generated by the aforementioned systems and components which are specifically configured to analyze and extract such information from customer journey and friction event data, is expressed via a user interface and/or electronic alerts. The information the user interface and/or electronic alerts provide enables the business to understand and streamline electronic transactions, processes, and systems associated with friction events, mitigate or avoid future friction events which can result in system inefficiencies and risk customer attrition, and improve customer satisfaction as a result. For example, friction from an electronic transactional event that results in the failure to open a new customer account can frustrate the customer and risk losing their business, as well as expend additional computing resources when repeating and/or executing steps and operations to rectify the friction and/or successfully open the account. The additional computing resources may include computer processing resources to process the data associated with opening the new account, network resources in transmitting the associated data, and memory resources to store the associated data, which may otherwise be unnecessary when implementing the disclosed techniques. Moreover, the disclosed techniques can be applied to identify friction events in multiple electronic customer journeys (e.g., hundreds, thousands, hundreds of thousands, etc.), even when the electronic customer journeys include unique and varied transactional events associated with the friction, thereby expanding the benefits the system provides respective to a single electronic customer journey.

In some embodiments, the friction events can be identified in real-time, or even predicted before they occur, based upon the analysis of various types of information obtained from multiple channels (e.g., electronic customer journey event monitoring data, customer feedback, customer communications). Such techniques can, for example, rapidly provide up-to-date information to prioritize addressing the most crucial friction events as they unfold, mitigate the impact of friction events on business operations and customer satisfaction in a timely manner, and/or avoid the friction events altogether.

The present disclosure includes specific features other than what is well-understood, routine, conventional activity in the field, and/or otherwise adds unconventional steps that confine the disclosure to a particular useful application, e.g., to identify one or more friction events during the electronic customer journey in a manner that allows proactive responses to friction, and enables the identification of improvements to computing systems and processes which may contribute to the frictions. The technical improvements and advantages described herein are not the sole improvements and advantages, and other improvements and advantages may be apparent to one of ordinary skill in the art.

### Example Computing Environment

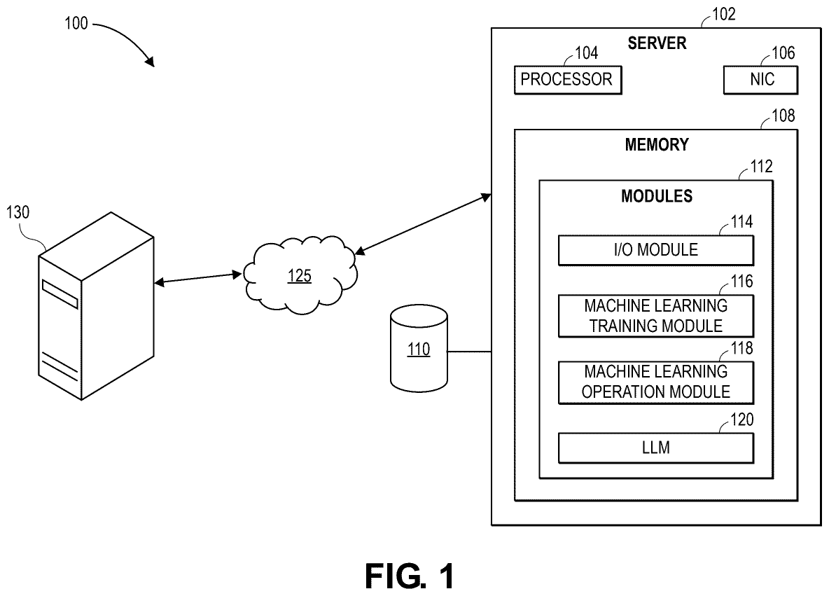

FIG. 1 depicts an example computing environment 100 to identify one or more friction events during an electronic journey of a customer of a business, according to some aspects. The computing environment 100 may include a server 102, a network 125, and a computing device 130.

The server 102 may include a processor 104, a network interface controller (NIC) 106, a memory 108, and a database 110. The server 102 may be part of a cloud network or may otherwise communicate with other hardware or software components within one or more cloud computing environments to send, retrieve, or otherwise analyze data or information described herein. In one example, in certain aspects of the present techniques, the computing environment 100 may comprise an on-premise computing environment, a multi-cloud computing environment, a public cloud computing environment, a private cloud computing environment, and/or a hybrid cloud computing environment. In one example, an entity (e.g., a business offering retirement services) may host one or more services in a public cloud computing environment, e.g., Amazon Web Services, Google Cloud, IBM Cloud, Microsoft Azure, etc. The public cloud computing environment may be a traditional off-premise cloud (i.e., not physically hosted at a location owned/controlled by the business). Alternatively, or in addition, aspects of the public cloud may be hosted on-premise at a location owned/controlled by the business. The public cloud may be partitioned using visualization and multi-tenancy techniques and/or may include one or more of software-as-a-service (SaaS), infrastructure-as-a-service (IaaS) and/or platform-as-a-service (PaaS).

The network 125 may be a single communication network, or may include multiple communication networks of one or more types (e.g., one or more wired and/or wireless local area networks (LANs), and/or one or more wired and/or wireless wide area networks (WANs) such as the Internet). The network 125 may enable bidirectional communication between the server 102, the computing device 130, and/or other devices and components of the computing environment 100. In one aspect, the network 125 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally, or alternatively, the network 125 may comprise one or more routers, wireless switches, or other such wireless connection points communicating to the components of the computing environment 100 via wireless communications based upon any one or more of various wireless standards, including by non-limiting example, IEEE 802.11a/ac/ax/b/c/g/n (Wi-Fi), Bluetooth, and/or the like.

The server 102 may include a processor 104. The processor 104 may include one or more processors, such as one or more central processing units (CPUs), graphics processing units (GPUs), and/or any other suitable processor. The processor 104 may be communicatively coupled to the memory 108 via a computer bus (not depicted) to create, read, update, transmit, delete, or otherwise access or interact with the data, data packets, or otherwise electronic signals to and from the processor 104 and the memory 108, e.g., in order to implement or perform the machine-readable instructions, methods, processes, elements, or limitations, as illustrated, depicted, or described for the various flowcharts, illustrations, diagrams, figures, and/or other disclosure herein. The processor 104 may interface with the memory 108 via a computer bus to execute an operating system and/or computing instructions contained therein, and/or to access other services/aspects. For example, the processor 104 may interface with the memory 108 via the computer bus to create, read, update, delete, or otherwise access or interact with the data stored in the memory 108 and/or the database 110.

The server 102 may include the NIC 106 which allows the server 102 to communicate over the network 125 (e.g., with the computing device 130, the database 110) via any suitable wired and/or wireless connection, and/or interface of the NIC 106. The NIC 106 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the server 102 connected to the network 125.

The server 102 may include the memory 108. The memory 108 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 108 may store machine-readable instructions executable by the processor 104.

The memory 108 may store applications, such as the operating system (e.g., Microsoft Windows, Linux, UNIX, etc.) capable of facilitating the functionalities, applications, methods, or other software as discussed herein. In general, a computer program or computer based product, application, instructions, or code (e.g., machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in the memory 108) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The server 102 may include, and/or have access to (e.g., via the network 125), the database 110. The database 110 may include one or more databases. The database 110 may be or include a relational database, such as Oracle, DB2, MySQL, a NoSQL based database, such as MongoDB, or another suitable database. The database 110 may store data and/or datasets discussed herein, such as electronic customer journey datasets, ML training data/datasets, one or more ML models (e.g., the fine-tuned LLM), and/or friction event information. The dataset may include one or more types of data, records, files, etc. The terms “data” and “dataset” may be used interchangeably herein.

The server 102 may include modules 112. Each of the modules 112 implements specific functionality related to the present techniques, as will be described further, below. In aspects wherein the server 102 is implemented using multiple servers, different servers may include different modules 112. For example, a first server may include the ML training module 116 to train one or more ML models, while another server may include ML operation module 118 to operate one or more ML models trained by the first server ML training module 116. The modules 112 may exchange data among the devices of the computing environment via the network 125. The modules 112 of FIG. 1 will now be described in greater detail.

Generally, the I/O module 114 includes instructions that enable a user of the server 102 to access and operate the server 102 (e.g., directly via user interface of the server 102, via the computing device 130 communicatively connected to the server 102 over network 125, etc.). For example, the server 102 may train an ML model using the ML training module 116. Once the ML model is trained, the user may access the server 102 via the I/O module 114 to use the trained model. The I/O module 114 may include instructions for generating one or more graphical user interfaces (GUIs), such as GUIs to display friction event information. The I/O module 114 may include a communication component configured to communicate (e.g., send and receive) data via one or more external/network port(s) to one or more networks (e.g., the network 125) or components/devices, such as the computing device 130.

In one aspect, the modules 112 may include an ML training module 116 and/or an ML operation module 118. In some embodiments, at least one of a plurality of ML methods and algorithms may be applied by the ML training module 116 and/or the ML operation module 118, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on the server 102. For example, libraries may include the TensorFlow based library, the PyTorch library, and/or the scikit-learn Python library.

In one embodiment, the ML training module 116 may employ supervised learning, which involves identifying patterns in existing data to make predictions about subsequently received data. Specifically, the ML training module 116 trains using training data, which includes exemplary inputs and associated exemplary outputs. Based upon the training data, the ML training module 116 may generate a predictive function which maps outputs to inputs and may utilize the predictive function to generate ML outputs based upon data inputs. The exemplary inputs and exemplary outputs of the training data may include any of the data inputs or outputs described with respect to the ML models. In the exemplary embodiments, a processing element may be trained by providing it with a large sample of data with known characteristics or features.

In another embodiment, the ML training module 116 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML training module 116 may organize unlabeled data according to a relationship determined by at least one ML method/algorithm employed by the ML training module 116. Unorganized data may include any combination of data inputs and/or outputs as described herein with respect to the ML models.

In yet another embodiment, the ML training module 116 may employ reinforcement learning, which involves optimizing outputs based upon feedback from a reward signal. Specifically, the ML training module 116 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML training module 116 may receive labeled data at an input layer of a model having a networked layer architecture (e.g., an artificial neural network, a convolutional neural network, etc.) for training the ML model. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the ML model. The output layer may be trained to output a prediction, for example.

The ML operation module 118 may comprise a set of computer-executable instructions implementing ML loading, configuration, initialization and/or operation functionality. The ML operation module 118 may include instructions for storing trained models (e.g., in the databases 110). As discussed, once trained, the trained ML model may operate in inference mode, whereupon when provided with de novo input that the ML model has not previously been provided, the ML model may output one or more predictions, classifications, etc., as described herein.

In operation, ML model training module 116 may access the database 110, or any other data source for training data suitable to generate the ML model. The training data may be sample data with relevant and comprehensive labels (classes or tags) used to fit the parameters (weights) of the ML model with the goal of training it by example. In one aspect, once an appropriate ML model is trained and validated to provide accurate predictions and/or responses, the trained model may be loaded into ML operation module 118 at runtime to process input data and generate output data.

While various embodiments, examples, and/or aspects disclosed herein may include training and generating one or more ML models for the server 102 to load at runtime, additionally or alternatively, one or more trained ML models may already exist (e.g., in the database 110) such that the server 102 may load an existing trained ML model at runtime. In some implementations, the server 102 may retrain, fine-tune, update and/or otherwise alter an existing ML model, such as before and/or after loading the ML model at runtime.

In one aspect, the modules 112 may include an LLM 120. Although the LLM 120 is illustrated in FIG. 1 as residing in the memory 108, in other embodiments, the LLM 120 may be stored in the database 110, and/or in any other suitable memory communicatively coupled to the server 102. The LLM 120 may be designed and/or trained to understand and/or generate human-like language and/or text. The LLM 120 may perform various natural language processing tasks and generate coherent and contextually relevant text. In at least some aspects, the LLM 120 may be a pre-trained LLM (e.g., GPT, Gemini, PaLM 2, Llama 2) which is fine-tuned with training data indicating terms relevant to detecting friction in an electronic customer journey. For example, the term “nest egg” in the context of financial planning may refer to funds set aside for retirement, rather than an animal egg located in a nest. In at least some aspects, the LLM 120 may determine one or more topics or customer sentiments associated with a friction event, as further described herein.

The computing environment may include the computing device 130. The computing device 130 may be, and/or include, a server, a mobile computing device, a smart phone, a tablet, a laptop, a wearable device, or any other suitable type of computing device or system (e.g., a collection of computing resources). The computing device 130 may include a processor and NIC, such as the processor 104 and the NIC 106. The computing device 130 may include respective input device(s) and a respective output device(s). The respective input devices may include any suitable device or devices for receiving input, such as one or more microphone, one or more camera, a hardware keyboard, a hardware mouse, a capacitive touch screen, etc. The respective output devices may include any suitable device for conveying output, such as a hardware speaker, a computer monitor, a touch screen, etc. In some cases, the input device and the output device may be integrated into a single device, such as a touch screen device that accepts user input and displays output. The computing device 130 may be associated with identifying one or more friction events during an electronic customer journey. For example, the computing device 130 may access and/or display a user interface including the friction event information.

In operation, the computing environment 100 may identify one or more friction events during an electronic customer journey. In one embodiment, the server 102 is associated with a business, and obtains a plurality of electronic customer journey datasets. The electronic customer journey datasets indicate electronic customer journeys of the business' customers. The server 102 may obtain the at least a portion of the electronic customer journey datasets from one or more sources, such as from the memory 108, the database 110, another server 102 via the network 125, and/or any suitable source of electronic customer journey datasets. In one aspect the electronic customer journey dataset may include one or more types of data. In one example, the electronic customer journey dataset includes customer feedback data indicating customer feedback, e.g., feedback provided via a customer survey, online support forum, and/or any other suitable customer feedback. In one example, the electronic customer journey dataset includes digital transaction event data from online or electronic transactions, e.g., data from browsing the website data, accessing online account information, processing electronic documents such as investment beneficiary paperwork, and/or other suitable online or digital transactions. In one example, the electronic customer journey dataset includes customer communication data from customer communications between the customer and the business, such as emails, telephone calls, online chat, and/or any other suitable customer communication with the business. In such an aspect, the various types of data comprising the electronic customer journey dataset may be collected by various entities and/or systems and components of the computing environment 100, and obtained by the server 102 therefrom.

The server 102 may analyze and least one of the electronic customer journey datasets to identify one or more frictions events that negatively impact completion of an associated transaction. The friction event may include a technical issue (e.g., broken webpage hyperlinks, inability to access online account data, etc.), a data processing issue (e.g., rejection of a customer form due to a missing signature), delay of a transactional event (e.g., delay receiving credit approval because of the credit application processor is on vacation), the non-completion of a transactional event (e.g., a request to close an account is not fulfilled), and/or any other suitable friction event.

The server 102 may use rules, algorithms, artificial intelligence, machine learning, and/or other suitable means to analyze the data to predict and/or detect one or more friction events. In at least one aspect, the server 102 analyzes the electronic customer journey datasets using friction identification rules to identify friction events. The friction identification rules may detect patterns and/or anomalies during the electronic customer journey which are indicative of friction events. In at least one aspect the, the friction identification rules are based upon business knowledge indicating best practices of the business. In one example, the friction identification rules may indicate that a request to roll over a 401k retirement plan is generally processed within five business days. If a customer's electronic customer journey dataset indicates (e.g., from digital transaction data of the electronic customer journey dataset) that the customer submitted the roll over request eight business days, and the request remains unprocessed, this may indicate a friction event based upon business best practices. The friction identification rules may identify the delay in processing the request as a friction event when analyzing the associated electronic customer journey dataset via the server 102. If the roll over request remains unprocessed after four and one-half business days, just shy of the five business days, the server 102 may predict that the request will result in a friction event (e.g., delayed processing beyond five business days), and the predicted processing delay may be identified as the friction event. It at least one aspect, the friction event may be identified in real-time, or substantially in real-time, e.g., based upon real-time information in the electronic customer journey datasets, and real-time analysis of the electronic customer journey datasets, to identify the friction-events. For example, when the user account section of a business website becomes inoperable during a customer browsing session, the server 102 may detect the error as a friction event, and provide a real-time alert to the technology support department at the business so they may resolve the issue, provide a real-time alert to the customer service department to have them contact the customer to discuss their account, and a real-time alert to the customer acknowledging the error and informing them they will be contacted shortly.

In response to identifying the friction event in the electronic customer journey dataset, the server 102 may generate friction event information. The friction event information may include any information associated with friction event, such an indication of what the friction event is, the cause of the friction event, ancillary issues due to the friction event, the customer response to the friction event, and/or any other suitable information. In one aspect, the friction event information may be stored in one or more memories, such as the memory 108, the database 110 (e.g., a knowledgebase database), on another server 102, etc. In one example, the friction event information may be used to create new friction identification rules, update and/or improve existing friction identification rules, generate analytics associated with friction events, train/retrain/fine-tune the LLM 120, and/or other suitable purposes.

The server 102 may provide the friction event information to the LLM 120, such as an LLM which is fine-tuned with training data associated with terminology and concepts relevant to business operations, electronic customer journeys, friction events, customer sentiment, and/or any other suitable training data/information. The LLM 120 may determine one or more topics and/or customer sentiments associated with the friction event, as indicated by the friction event information. The customer sentiments the LLM 120 determines may be categorized as positive sentiment(s) (e.g., the customer is pleased, happy, has left positive feedback, etc.), negative sentiment(s) (e.g., unhappy, frustrated, annoyed, negative feedback), or neutral sentiment(s) that are neither positive nor negative. Other sentiments besides, positive, negative, and neutral may be generated by the LLM 120.

In one example, the friction event information indicates that the customer sends a harshly-worded feedback email to a business in response to a friction event in which they are unable to access their online account to deposit funds. The LLM 120 may receive the friction event information associated with the friction event, and determine that the associated topics include “online account,” “feedback email,” and “deposit,” and the associated customer sentiments include “negative” due to the harsh-wording. The LLM 120 may indicate the topics and customer sentiments in the friction event information, e.g., via labeling existing data, creating metadata, and/or other suitable means. However, the server 102 and/or LLM 120 may indicate and/or store information associated with the topics and customer sentiments of the friction event in any other suitable manner, e.g., by creating data, the friction event information, associated with topics and customer sentiments.

The server 102 may generate a user interface (UI), such as a graphical user interface, including the friction event information, and/or one or more electronic alerts. Generating the UI and/or alerts permits relevant stakeholders (e.g., technical members) and/or the customer associated with the friction event to be informed about the friction event and/or can take corrective actions to address the friction (e.g., resolve the friction event, improve systems and processed to avoid similar friction, etc.). The UI may be accessible via the computing device 130. For example, the computing device 130 may execute a client application associated with identifying friction events. The computing device 130 may be communicatively connected to the server 102 via the network 125. The application may be configured to receive the UI generated by the server 102, and display the UI on a screen of the computing device 130. In one aspect, the UI may include a graphical depiction of at least a portion of the friction event information (e.g., graphs, charts, diagrams), friction event analytics (e.g., frequency of friction events, types of friction event topics and customer sentiments), a recommendation associated with the friction event (e.g., how to resolve an existing friction event, how to avoid a predicted friction event), and/or other suitable friction event information.

The server 102 may generate one or more electronic alerts based upon the friction event information. The electronic alert may indicate the occurrence of a friction event, the prediction of a friction event, a suggested action to avoid, mitigate, or resolve the friction event, or other suitable information. The server 102 may provide the electronic alert via an email, an application push notification, the UI, or in any other suitable manner. The alert may include audio, video, multimedia, a haptic alert, and/or any other type of alert. The server 102 may provide the electronic alert (e.g., via the network 125) to one or more computing devices 130.

The computing environment 100 may include additional, fewer, and/or alternate components, and may be configured to perform additional, fewer, or alternate actions, including components/actions described herein. For example, information described as being stored in the database 110 may be stored in the memory 108, and therefore the database 110 may be omitted. Moreover, it should be appreciated that additional and/or alternative connections between the components shown in FIG. 1 may be implemented. As just one example, server 102 and database 110 may be connected via the network 125 rather than, or in addition to, a direct communication link (not shown in FIG. 1).

### Example ML Model Training and Operation

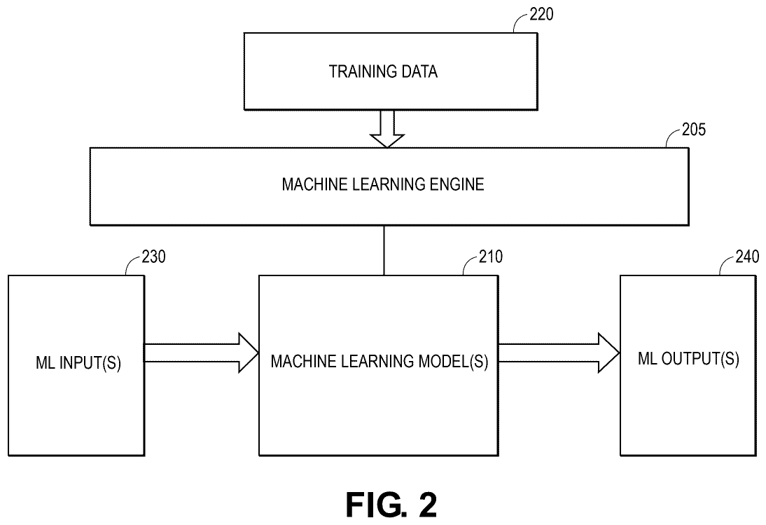

FIG. 2 depicts a data flow diagram for example training and operation of an ML model 210 (e.g., the LLM 120) used for identifying friction during a customer journey, according to some aspects. Although FIG. 2 illustrates an exemplary ML model training, this does not imply that the same set of training data, inputs, and outputs shown apply to all ML models, or that any specific technique discussed herein is necessarily used for all of the ML models, as further described below.

An ML engine 205 (e.g., the ML training module 116 and/or the ML operation module 118 of the server 102) may include one or more hardware and/or software components to obtain, create, (re)train, fine-tune, and/or store the ML model 210, such as the LLM 120. To train the ML model 210, the ML engine 205 may use training data 220. A server, such as the server 102, may obtain and/or have available one or more types of training data 220 (e.g., training data stored in the database 110). In one aspect, at least some of the training data 220 may be labeled to aid in (re)training and/or fine-tuning the ML model 210. During training of the ML model 210 by the ML engine 205, the ML model 210 may be configured to process the training data 220 to learn associations and relationships in the training data 220.

In some embodiments, the ML engine 205 updates the training data 220 as needed, e.g., to include new data. Such data may be stored as updated training data 220. Subsequently, the ML model 210 may be retrained (e.g., via the ML engine 205) using the updated training data 220, or the new portions thereof, which may cause the ML model 210 to improve over time.

In some embodiments, the ML engine 205 trains the ML model 210 using the training data 220 to generate the output 240 based on the input 230. Once trained, the ML model 210 may perform operations on one or more data inputs 230 to produce a desired data output 240, such the friction event topics and customer sentiments, as described above. In one aspect, the ML model 210 is loaded at runtime from a database (e.g., the LLM 120 loaded by ML engine 205 from the database 110). The server and/or ML engine 205 may obtain the input data 230 (e.g., from the database 110), and the ML engine 205 may provide the input data 230 to the trained ML model 210 as an input, for the ML model 210 to generate the output 240.

In at least some aspects, the same server and/or other suitable component/device, both trains the ML model 210, and executes the trained ML model 210. In at least some aspects, a first server and/or other suitable component/device trains the ML model 210, and a second server and/or other suitable component/device executes the trained ML model 210.

### Generative ML Models

In one embodiment, the ML model 210 is a generative ML model. In one aspect, the generative model. The generative model may be trained by the ML engine 205 to include generative functionality for creating new content that is in some ways similar to, or otherwise inspired by, existing examples, and/or reflective of desired features/characteristics. In one aspect, generative ML model is the ML model trained and/or configured to generate topics and customer sentiments associated with friction events. As described above, in some of these embodiments, the ML model 210 is and/or includes an LLM, such as the LLM 120. The LLM may operate upon and only generate text (e.g., text associated with fiction event topics and customer sentiments) or, in other embodiments, may be a multimodal LLM that operates upon and/or generates text and also other types of content (e.g., images such as cloud readiness prioritization heatmaps, audio such as audio-based responses, etc.).

In one embodiment, the ML engine 205 trains the LLM, or otherwise receives a trained LLM, and fine-tunes the LLM, e.g., to have additional functionality and/or understanding. For example, the trained LLM, which in this example is referred to as a pre-trained LLM, is able to successfully analyze and understand words. However, and as previously described, text/words/phrases may have a different meaning in certain contexts, such as terms of art specific to the finance industry, like “bull market” to refer to conditions of the financial stock market, as opposed to a market of bulls (the animal). Rather than train a new LLM from scratch with training data associated with terminology specific to the finance industry, the pre-trained LLM may be fine-tuned (e.g., further trained) using training data associated with terminology specific to the finance industry. The fine-tuning allows the LLM to retain the knowledge of general language understanding from its original training, and gain new knowledge to understand the specialized terminology for the finance industry from fine-tuning, without training the model completely from scratch, thereby creating a new, fine-tuned LLM. The fine-tuning process saves time, effort, and computing resources as compared to training a new model, e.g., less memory to store fine-tuning training data than larger training dataset were the model created from scratch; shorter training time requiring less utilization of the processor, and the like.

The generative ML model may include a deep neural network and may perform various natural language processing (NLP) tasks (e.g., classifying text, answering questions, summarizing text such as human-readable code, generating text such as human-readable code) as needed to understand a text query/prompt and generate a response to the text query/prompt. As one example, the prompt may be “Summarize the topics of this customer feedback email.”

The LLM may have a transformer model architecture with an encoder and decoder, and may tokenize characteristic inputs/text. The transformer model may incorporate self-attention mechanisms to facilitate faster learning/training and/or more accurate output. In some embodiments, the LLM includes many layers of neural networks, possibly including a number of embedding layers, a number of feedforward layers, and a number of recurrent layers.

The generative ML model may have been trained by the server 102, or another computing system using unsupervised or semi-supervised learning, for example, and with training data of the appropriate modality (text) or modalities (e.g., text as well as images and/or audio). The ML chatbot may be a general-purpose model (e.g., trained on a wide array of publicly available datasets such as web pages, documents, etc., available via the Internet), such as the pre-trained LLM referred to above, or may be a domain-specific model (e.g., trained on custom and/or proprietary datasets, such as training data corresponding to business best practices, friction events, financial terminology, and/or other domain-specific information associated with identifying friction during a customer journey).

In some embodiments, the LLM is tuned with parameters, via the training process, specifically for high performance in generating topics and customer sentiments associated with a friction event. For example, the LLM may receive text from a real-time customer service chat feed with a customer that is related to a friction event associated with opening an account, and be able to generate topics and customer sentiments from the chat text, in real-time.

### Example System for Detecting Friction During an Electronic Customer Journey

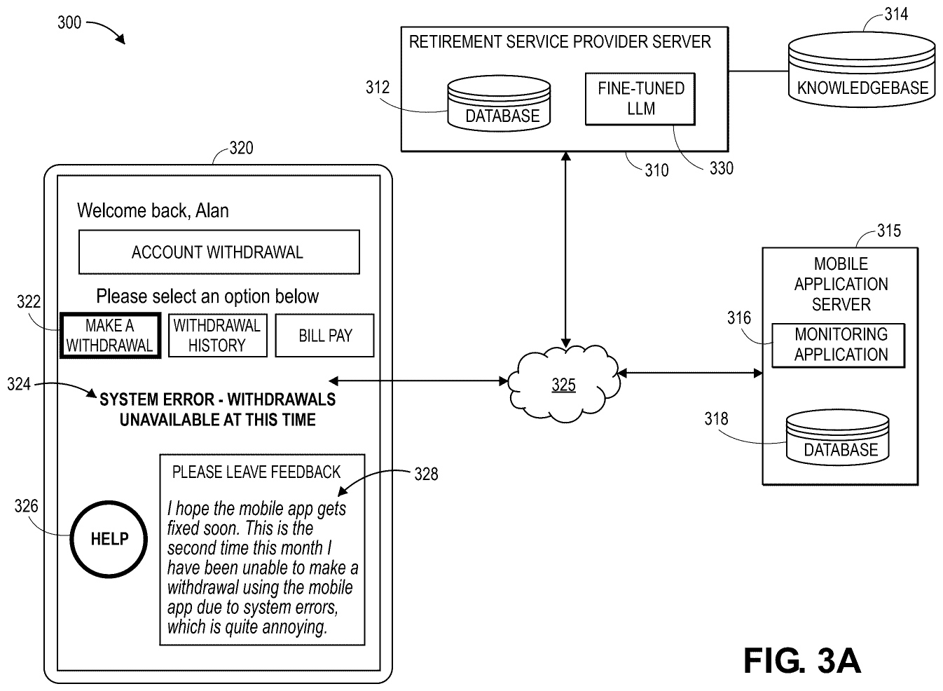

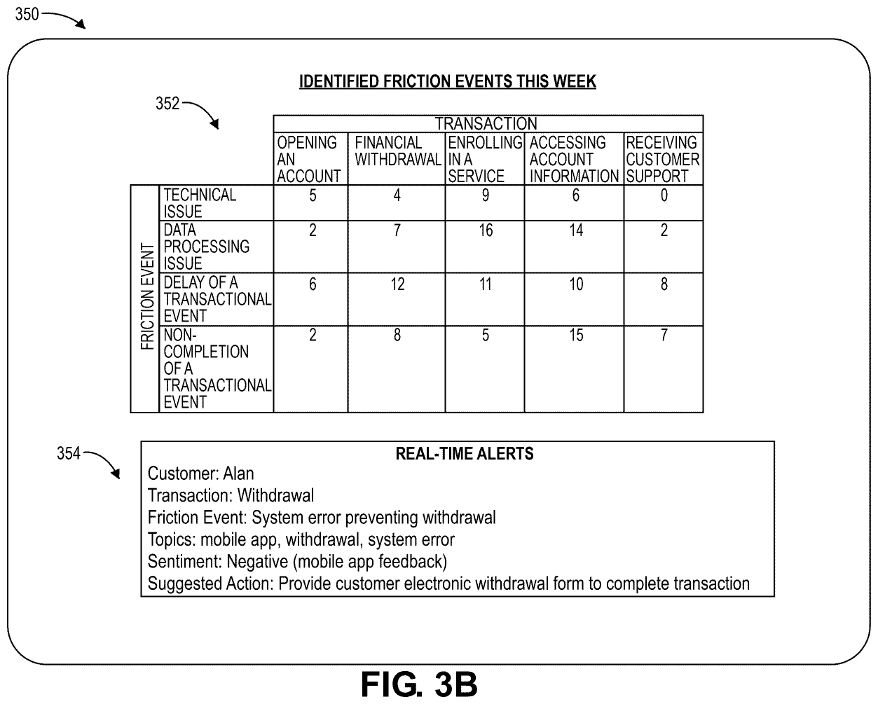

FIG. 3A depicts an example block diagram of a system 300 for detecting friction during an electronic customer journey, according to an embodiment. The system 300 includes a retirement service provider server 310 such as the server 102, a mobile application server 315 such as the server 102, and a smartphone 320 such as the computing device 130, communicatively coupled via a network 325 such as the network 125.

In one example, a customer Alan would like to conduct a transaction with his retirement account provider, more specifically a transaction to make a withdrawal from his retirement account. Alan uses his smartphone 320 to execute a mobile application associated with his retirement service provider to make the withdrawal. He navigates to the withdrawal section of the mobile application, and selects an icon 322 to make a withdrawal. Unfortunately, when Alan selects the icon 322 to make the withdrawal, the mobile application displays an error message 324 that the withdrawals are unavailable due to a system error.

A mobile application server 315 hosting the mobile application includes a monitoring application 316. The monitoring application 316 monitors operations of the mobile application server 315, and generates transactional event data for transactional events taking place via the mobile application. The transactional events may correspond to transactions (e.g., opening an account, a financial withdrawal, enrolling in a service, accessing account information, receiving customer support, etc.) between the retirement service provider and its customers during electronic customer journeys, which are carried out using the mobile application. The monitoring application 316 monitors Alan's mobile application activity, and generates a first electronic customer journey dataset associated with Alan attempting to withdraw retirement funds using the mobile application. The first electronic customer journey dataset includes transactional event data associated with the transactional events of the mobile application withdrawal, including opening the mobile application, navigating to the withdrawal section of the mobile application, selecting the icon 322 in the mobile application to make the withdrawal, and receiving the system error message 324 in the mobile application. The monitoring application 316 stores the first electronic customer journey dataset in a database 318, such as the database 110, of the mobile application server 315.

After encountering the system error, Alan selects a “help” icon 326 displayed by the mobile application, and leaves feedback 328 about his experience. The feedback 328 states, “I hope the mobile application gets fixed soon. This is the second time this month I have been unable to make a withdrawal using the mobile application due to system errors, which is quite annoying.” Alan submits the feedback 328 to the retirement service provider server 310 via the mobile application. The retirement service provider server 310 stores Alan's feedback 328 as feedback data in a database 312, such as the database 110, of the retirement service provider server 310. The mobile application server 315 also generates additional transactional event data corresponding to Alan leaving feedback via the mobile application, and includes the additional transaction event data in the first electronic customer journey dataset.

The retirement service provider server 310 determines that Alan's feedback 328 is associated with the mobile application withdrawal attempt indicated by the first electronic customer journey dataset stored in the database 318, both of which are part of a single electronic customer journey by Alan to conduct a withdrawal transaction with the retirements service provider via the mobile application. In one example, the retirement service provider server 310 determines the correlation between the Alan's feedback 328 and the mobile application withdrawal based upon timestamps in the feedback data and first electronic customer journey dataset indicating that Alan leaves the feedback 328 directly after receiving the system error message 324 in the mobile application. In one example, the retirement service provider server 310 determines the correlation between the Alan's feedback 328 and the mobile application withdrawal based upon information identifying Alan as the customer in the feedback data and first electronic customer journey dataset, such as data indicating Alan's customer identification number, or data indicating the smartphone 320 executing the mobile application is associated with Alan. However, other suitable methods may be used to associate the feedback 328 of the feedback data with the attempted mobile application withdrawal of the first electronic customer journey dataset.

In one aspect, based upon the association between the feedback data and the first electronic customer journey dataset, the retirement service provider server 310 may retrieve, via the network 325, the first electronic customer journey dataset from the database 318 of the mobile application server 315. The retirement service provider server 310 may include the feedback data in the first electronic customer journey dataset, and store the first electronic customer journey dataset in the database 312. Although the electronic customer journey dataset is described as being generated by, and stored at, the mobile application server 315, and the feedback data is described as being stored at the 310, this is for ease illustration only. Any suitable device of the system 300 may generate and/or store any of the various types of data described here. For example, the retirement service provider server 310 may generate the first electronic customer journey dataset and the mobile application server 315 may receive and store the feedback data from the smartphone 320. Moreover, the electronic customer journey dataset may include various types of information and/or data associated with the electronic customer journey. In one example, rather than leave feedback via the mobile application, Alan may call a customer support telephone number of the retirement service provider using his smartphone 320, and speak with a customer service agent to provide his feedback. The retirement service provider server 310 may generate customer communication data associated with the call, store the customer communication data in the database 312, and/or store the customer communication data in the first electronic customer journey dataset.

The retirement service provider server 310 may analyze a plurality of electronic customer journey datasets in real-time, and/or predict friction events indicated in the plurality of electronic customer journey datasets. The friction events may include technical issues (e.g., the mobile application system error), data processing issues (e.g., processing a social security number of the customer for a transaction, and discovering the social security number is incorrect), delay of transactional events (e.g., a delay in opening a retirement account with the retirement service provider), non-completion of transactional events (a request to be contacted by customer support which his not fulfilled), and/or any other suitable event that negatively impacts completion of the transaction.

The retirement service provider server 310 may use friction identification rules to identify the friction events in the electronic customer journey datasets. In at least one aspect, at least a portion of the friction identification rules may be based upon business knowledge indicating best practices of the retirement services provider. For example, best practices may indicate a new customer account should be opened in one business day, financial withdrawals above a certain amount require managerial authorization, etc. The friction identification rules may be configured to detect, in the electronic customer journey dataset, whether transactional events fall outside of these best practices, and if so, identify them as friction events. The friction identification rules may differ based upon the type of business, the type of transaction, the type of friction events to detect, or otherwise configured in any other suitable manner. The retirement service provider server 310 may store the friction identification rules, e.g., in system memory (e.g., memory 108), in the databases 312, 318, and/or in any other suitable memory communicatively coupled to the retirement service provider server 310.

Returning to the example of FIG. 3A, the retirement service provider server 310 identifies the friction event corresponding the system error Alan encounters while attempting the make the withdrawal using the mobile application, by applying the friction identification rules stored in the database 312 to the first electronic customer journey dataset. In response to identifying the friction event, the retirement service provider server 310 generates corresponding friction event information. The friction event information may include an indication of the date of the friction event, the customer is Alan, that the friction event is associated with a withdrawal attempt, that the friction event occurs when using the mobile application to make the withdrawal, the content of Alan's feedback associated with the friction event, and/or any other suitable information associated with the friction event. The friction event information may be included in the first electronic customer journey dataset, or may be data which is distinct from the first electronic customer journey dataset. In one aspect, the retirement service provider server 310 stores the friction event information in memory, such as a knowledgebase database 314 communicatively coupled to the retirement service provider server 310. The knowledgebase database 314 may be used to generate business rules, provide customer support, and/or any other suitable purpose.

The retirement service provider server 310 may provide the friction event information to a fine-tuned LLM 330, such as the LLM 120. The fine-tuned LLM 330 may be stored in a memory communicatively coupled the retirement service provider server 310. In one embodiment, the fine-tuned LLM 330 may include a pre-trained, base LLM which is fine-tuned to understand terms specific to the retirement service provider industry using training data indicating terms specific to the retirement service provider industry, as previously described. The fine-tuned LLM 330 may determine one or more topics and/or customer sentiments associated with the friction event, and indicated in the friction event information. The fine-tuned LLM 330 may determine that topics associated with Alan's friction event include “mobile application,” “withdrawal,” and “system error,” based upon Alan using the mobile application to attempt a withdrawal when the system error occurred. The fine-tuned LLM 330 may determine that customer sentiment associated with the friction event is negative based upon Alan's use of the word “annoying” in his feedback comment. The fine-tuned LLM 330 may indicate the topics and customer sentiment for Alan's friction event in the friction event information (e.g., via metadata indicating the topics and customer sentiment), and store the friction event information with the indicated topics and customer sentiment, in memory, such as the database 312.

The retirement service provider server 310 may generate a UI which is accessible via a computing device (e.g., Alan's smartphone 320, a computing device of the retirement service provider). In one aspect, the UI may include information about the plurality of electronic customer journeys and associated frictions events, such as the friction event information, friction event analytics, a recommendation associated with the friction event, and/or other suitable information. The UI may provide the information using tables, charts, multimedia (e.g., audio, video), a chatbot, or any other suitable method of conveying information via the UI. The retirement service provider server 310 may generate one or more alerts based upon the friction event information, such as a customer alert including a notification of the friction event, a retirement service provider alert including a notification of the friction event, a suggestion to resolve the friction event, a suggestion to avoid a predicted friction event, or any other suitable information. The retirement service provider server 310 may provide the alert to a computing device (e.g., to Alan's mobile application, a computing device of the retirement service provider), provide the alert via the UI, and/or provide the alert in any other suitable manner.

FIG. 3B depicts an example UI 350 for providing friction event information, according to an embodiment. The retirement service provider server 310 generates the UI 350, which includes a friction event analytics table 352 indicating weekly frictions events for a plurality of electronic customer journeys. The friction event analytics table 352 includes the type of transaction across the second row, the type of friction event along the second column from the left, and the number of friction events in the cells intersecting the rows and columns. The real-time alerts section 354 of the UI 350 identifies Alan's friction event, the associated topics and customer sentiment determined by the fine-tuned LLM 330, and a suggested action to resolve the friction event. The retirement service provider server 310 generates an alert which includes the suggested action, and provides the alert to the computing devices of the withdrawal department of the retirement service provider. The suggestion action of the alert indicates that, to resolve Alan's friction event preventing his withdrawal using the mobile application, an agent should provide Alan with an electronic withdrawal form that he can fill out using the mobile application to complete the withdrawal.

An agent in the withdrawal department receives the alert, and sends the electronic withdrawal form to Alan via the mobile application. Alan receives the electronic withdrawal form, which requests the withdrawal amount, as well as the routing and account numbers of the bank account he would like the withdrawal funds deposited into. Alan fills in the withdrawal amount and account number, but forgets a digit when adding the routing number rendering it invalid. Alan submits the electronic withdrawal form to the retirement service provider server 310 via the mobile application. The retirement service provider server 310 extracts the information Alan provides via the electronic withdrawal form, to generate a withdrawal request including the extracted information. While generating the generate the withdrawal request, the retirement service provider server 310 flags the routing number field upon detecting it is missing a digit. The retirement service provider server 310 may submit the withdrawal request to a withdrawal request processing queue, for approval by an agent in the withdrawal department. The approval process includes review of the flagged routing number information. The retirement service provider server 310 generates a second electronic customer journey dataset for Alan associated with the withdrawal transaction using the electronic withdrawal form. The second electronic customer journey dataset indicates the associated transactional events including: the withdrawal department agent sending Alan the electronic withdrawal, Alan receiving the form via the mobile application, Alan sending the electronic withdrawal form back to the retirement service provider server 310 via the mobile application; the retirement service provider server 310 extracting the information to generate the withdrawal request, the retirement service provider server 310 flagging the routing number filed in the withdrawal request, and adding the withdrawal request to the withdrawal request processing queue.

The retirement service provider server 310 processes the Alan's second electronic customer journey dataset using the friction identification rules. The best practices included in the friction identification rules indicate that when a routing number is flagged for review, ninety-five percent of the time the end result is not transacting the withdrawal, due to the withdrawal request information being “not in good order” (NIGO). As the routing number of Alan's withdrawal request is flagged for review and indicated as such in the second electronic customer journey dataset, the retirement service provider server 310 predicts a NIGO friction event when applying the friction identification rules to the second electronic customer journey dataset. In response to predicting the NIGO friction event, the retirement service provider server 310 generates second friction event information indicating the predicted NIGO friction event, and stores the second friction event information in the knowledgebase database 314.

The retirement service provider server 310 provides the second friction event information to the fine-tuned LLM 330. The fine-tuned LLM 330 determines that the topics associated with the predicted NIGO friction event include “withdrawal,” “electronic withdrawal form,” “routing number,” and “NIGO.” There is no customer sentiment associated with the predicted friction event, being that it is predicted and there is no associated customer feedback for the fine-tuned LLM 330 to analyze. The fine-tuned LLM 330 stores the second friction event information, including the associated topics, in the knowledgebase database 314.

Generally, upon manual review of the incorrect routing number of Alan's withdrawal request, the agent in the withdrawal department would indeed flag the withdrawal request information as NIGO, which would terminate the withdrawal request. Alan would only be made aware of the cancelled withdrawal request only after it is terminated. This would result in poor customer service due to the lack of information provided to Alan associated with the NIGO, frustration by Alan when realizing the withdrawal request is cancelled, the expenditure of more time and effort on the part of Alan to make a second withdrawal request. Moreover, the retirement service provider server 310 would expend additional computing resources of the retirement service provider server 310 to process the second withdrawal request, such as memory and processor resources to process the data associated with the second withdrawal request, generate and store the electronic customer journey dataset associated with the second withdrawal request, etc.

Advantageously, the retirement service provider server 310 is able to process Alan's second electronic customer journey dataset to predict the NIGO friction event, so that action can be taken to avoid Alan's withdrawal request being flagged as NIGO, and the withdrawal cancelled as a result. For example, the retirement service provider server 310 may update the UI 350 to include information associated with the predicted NIGO friction event. The retirement service provider server 310 may generate a second electronic alert associated with the predicted NIGO friction event, and transmit the second electronic alert to the mobile application of Alan's smartphone 320. The second alert may provide the incorrect routing number, and ask Alan to verify the routing number to avoid the withdrawal request being cancelled. The timeliness of the request allows Alan to resubmit the correct routing number back to the retirement service provider server 310, while his withdrawal request is still in queue, to avoid the request being cancelled.

### Example Computer-Implemented Method for Identifying Friction Events During an Electronic Customer Journey

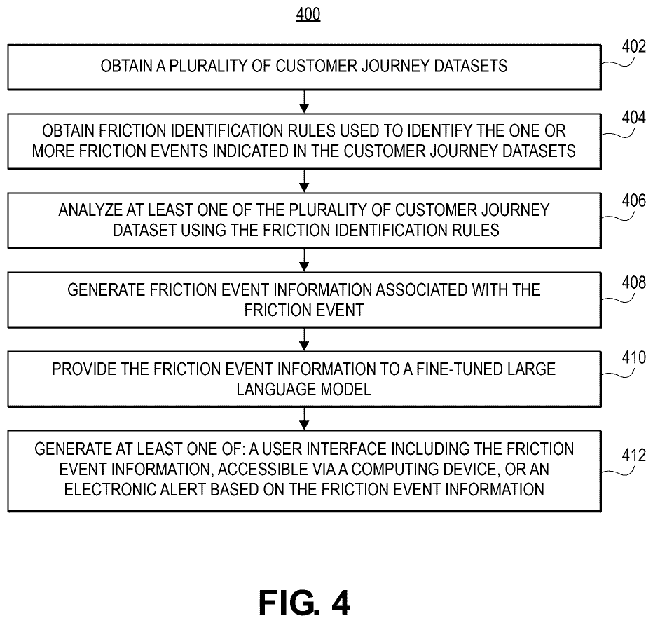

FIG. 4 depicts a computer-implemented method 400 for identifying one or more friction events during a customer's journey with a business. The computer-implemented method 400 may be implemented using one or more processors and, one or more memories storing computer-executable instructions, such as the processor 104 and memory 108 of the computing environment 100 to perform the steps of the computer-implemented method 400.

The computer-implemented method 400 may include obtaining, via the one or more processors, a plurality of electronic customer journey datasets (block 402). At least one of the electronic customer journey datasets may correspond to the electronic journey of the customer, correspond to a transaction between the customer and the business, and/or indicate one or more transactional events associated with the transaction. Obtaining the plurality of electronic customer journey datasets (block 402) may include receiving, aggregating and/or retrieving from one or more sources (e.g., the memory 108, one or more databases 110, one or more servers 102) data comprising the electronic customer journey datasets, such as online transactional event data, customer feedback data, and/or customer communication data. In at least one aspect, the transaction includes one or more of: opening an account (e.g., financial account, retirement account, investment account), a financial withdrawal, enrolling in a service (e.g., retirement planning, credit monitoring), accessing account information, receiving customer support, or other suitable customer transaction with the business.

The computer-implemented method 400 may include obtaining, via the one or more processors, friction identification rules used to identify the one or more friction events indicated in the at least one of the plurality of electronic customer journey datasets (block 404). The friction identification rules may be based upon business knowledge indicating transaction best practices.

The computer-implemented method 400 may include analyzing, via the one or more processors, at least one of the plurality of electronic customer journey dataset using the friction identification rules (block 406). Analyzing the electronic customer journey datasets using the friction rules may identify friction events during the corresponding electronic customer journey. The friction events may include technical issues, data processing issues, delays of transactional events, non-completion of transactional events, and/or other suitable friction events. In at least one aspect of the computer-implemented method 400, analyzing at least one of the plurality of electronic customer journey datasets using the friction identification rules (block 406) may include generating, via the one or more processors, a prediction of the one or more friction events. In at least one aspect of the computer-implemented method 400, the friction events are identified in real-time.

Responsive to identifying a friction event, the computer-implemented method 400 may include generating friction event information associated with the friction event (block 408). The friction event information may include details about the associated friction event (e.g., type of event, cause, etc.), its impact on the electronic customer journey, suggestions to resolve/mitigate the friction event, etc. In at least one aspect, the computer-implemented method 400 may include storing the friction event information in a knowledgebase database accessible by the computing device.

The computer-implemented method 400 may include providing, via the one or more processors, the friction event information to a fine-tuned LLM. The fine-tuned LLM may be configured to: (i) determine one or more topics associated with the friction event of the friction event information, (ii) determine one or more sentiments of the customer associated with the friction event of friction event information, and/or (iii) generate an indication, in the friction event information, of the one or more topics and/or the one or more sentiments.

The computer-implemented method 400 includes generating at least one of: a user interface including the friction event information, accessible via a computing device, or an electronic alert based on the friction event information (block 412). In at least one aspect of the computer-implemented method 400, the user interface includes a graphical depiction of at least a portion of the friction event information, friction event analytics, a recommendation associated with the friction event, and/or other suitable information. In at least one aspect of the computer-implemented method 400, the electronic alert indicates a suggested action to mitigate the corresponding friction event.

It should be understood that not all blocks of the exemplary flow diagram are required to be performed.

### Example Electronic Customer Journey

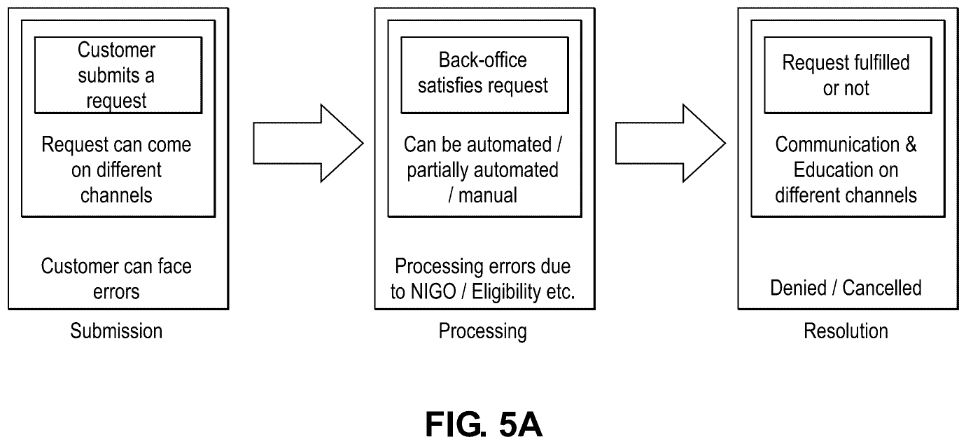

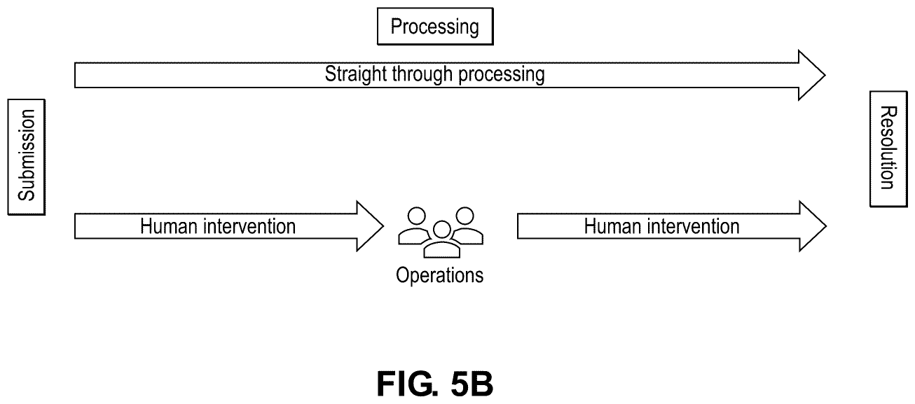

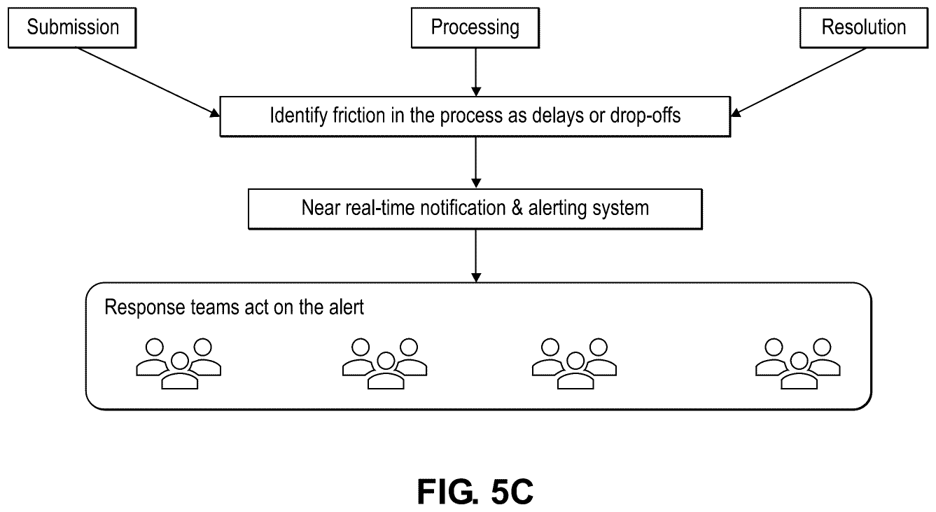

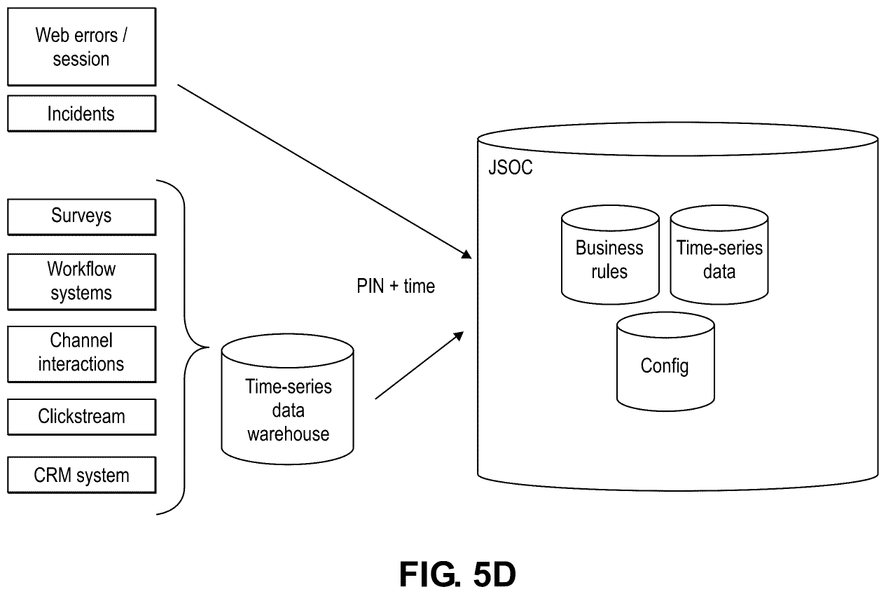

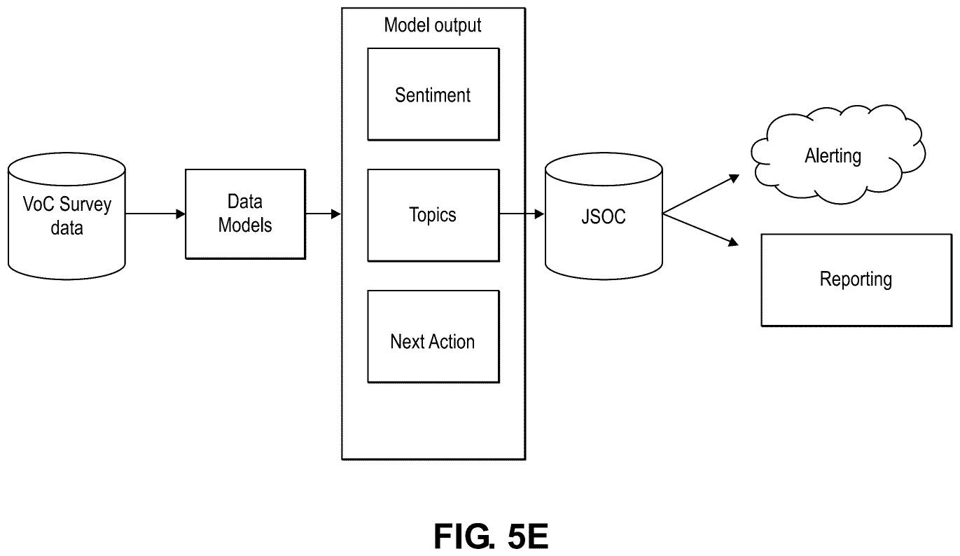

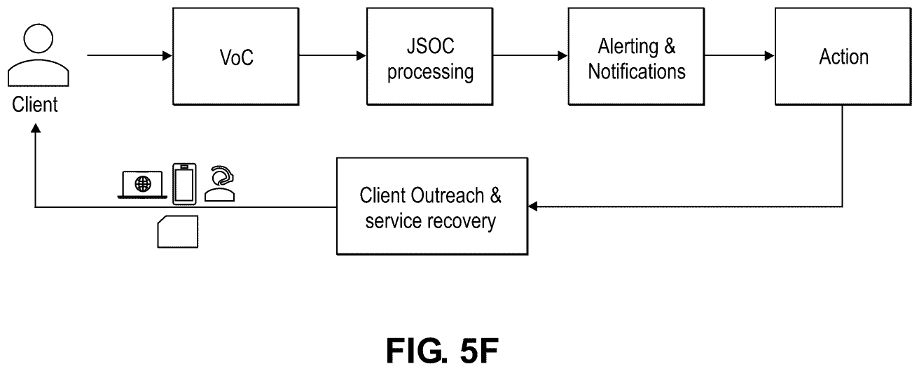

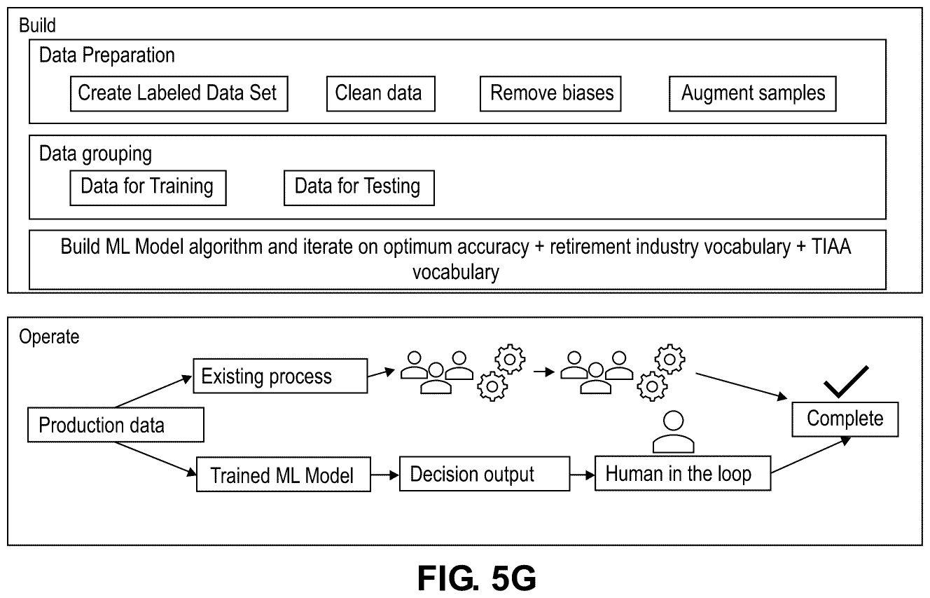

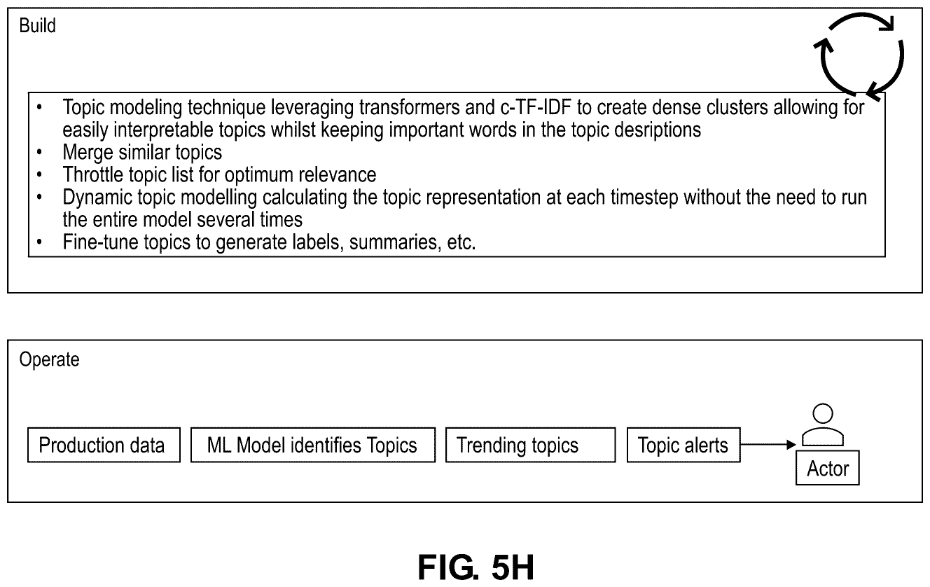

FIG. 5A depicts a flow diagram of an example electronic customer journey workflow, according to some embodiments. A customer journey may begin with the submission of a customer request to conduct a transaction. The request may be submitted through one or more channels (e.g., website, submission of a form associated with the transaction, a call to the business, etc.). The request may be submitted by a customer of the business or on the customer's behalf. Some example transactions the request may be associated with include a withdrawal from an employer-sponsored or individual retirement account, updating personal information, or receiving retirement services support through a digital channel. One example of friction a customer can face during the request submission is a website error that prevents the customer from submitting the request via a digital channel.

After receipt of the request, the business may process the request manually, in an automated fashion, or some combination thereof. This may include reviewing and promoting workflow tasks in order to fulfil a request, updating information in a system, running processes, etc. One example of automated processing of a request includes a customer submitting a beneficiary update online that is processed by a system of the business without any human intervention. One example of a partially automated processing of the request would be a funds transfer that requires a human (e.g., the customer, a business employee) to electronically transfer funds between accounts. One example of manual processing of a request is a withdrawal request submitted by a customer that requires a business employee to create an associated workflow task, enter and confirm the withdrawal information, etc. FIG. 5B depicts a block diagram of an example work flow for processing a request in an automated straight through manner, and processing the request including manual intervention, according to some embodiments.

There are multiple causes for a friction event associated with a request, such as a form not being in good order (NIGO) or the requestor not being eligible for the type of request submitted. For example, a withdrawal form may be missing a spousal waiver, the spousal waiver may not be notarized, the customer may not be eligible to withdrawal money from a retirement account due to their work status, and/or other suitable causes of a friction event. Any of these examples may cause processing of the request to be delayed and/or cancelled altogether, requiring the customer to resubmit the request anew, which is an undesirable experience for the customer. However, if the friction event is identified during the submission or processing of the request, alerts and/or an appropriate responses may occur to alleviate the friction and avoid the undesirable effects on the customer. FIG. 5C depicts an example work flow for identifying friction and generating associated notifications, according to some embodiments.

FIG. 5D depicts an example flow of data used for identifying friction during an electronic customer journey, according to some embodiments.

FIG. 5E depicts an example flow of data for identifying friction during an electronic customer journey using voice of the customer survey data, according to some embodiments.

FIG. 5F depicts an example flow of data for identifying friction during an electronic customer journey using closed loop feedback, according to some embodiments.

FIG. 5G depicts an example flow of data for identifying friction during an electronic customer journey using structured learning, according to some embodiments.

FIG. 5H depicts an example flow of data for identifying friction during an electronic customer journey using structured learning, according to some embodiments.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “of” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A system to identify one or more friction events during an electronic journey of a customer of a business, the system comprising:
one or more processors; and
one or more memories having stored thereon a set of computer-executable instructions that, when executed, cause the one or more processors to:
obtain, via the one or more processors, a plurality of electronic customer journey datasets,
wherein at least one of the plurality of electronic customer journey datasets,
corresponds to the electronic journey of the customer,
corresponds to a transaction between the customer and the business, and
indicates one or more transactional events associated with the transaction;
obtain, via the one or more processors, friction identification rules used to identify the one or more friction events indicated in the at least one of the plurality of electronic customer journey datasets,
wherein a friction event is an event that negatively impacts completion of the transaction;
analyze, via the one or more processors, the at least one of the plurality of electronic customer journey datasets using the friction identification rules;
responsive to identifying a friction event, generate, via the one or more processors, friction event information associated with the friction event;
provide, via the one or more processors, the friction event information to a fine-tuned large language model (LLM), stored on the one or more memories, and configured to:
determine one or more topics associated with the friction event of the friction event information,
determine one or more sentiments of the customer associated with the friction event of friction event information, and
generate an indication, in the friction event information, of the one or more topics and/or the one or more sentiments; and
generate, via the one or more processors, at least one of:
(i) a user interface including the friction event information,
wherein the user interface is accessible via a computing device; or
(ii) an electronic alert based upon the friction event information.

2. The system of claim 1, wherein the at least one of the plurality of electronic customer journey datasets includes one or more of: customer feedback data, digital transaction event data, or customer communication data.

3. The system of claim 1, wherein the transaction includes one or more of: opening an account, a financial withdrawal, enrolling in a service, accessing account information, or receiving customer support.

4. The system of claim 1, wherein the friction identification rules are based upon business knowledge indicating transaction best practices.

5. The system of claim 1, wherein the friction event includes one or more of: a technical issue, a data processing issue, delay of a transactional event, or non-completion of a transactional event.

6. The system of claim 1, wherein the user interface includes one or more of: a graphical depiction of at least a portion of the friction event information, friction event analytics, or a recommendation associated with the friction event.

7. The system of claim 1, wherein the electronic alert indicates a suggested action to mitigate the corresponding friction event.

8. The system of claim 7, further comprising instructions that, when executed by the one or more processors, causes the one or more processors to:
store, via the one or more processors, the friction event information in a knowledgebase database accessible by the computing device.

9. The system of claim 1, where to analyze the at least one of the plurality of electronic customer journey datasets using the friction identification rules, the system further comprises instructions that, when executed by the one or more processors, causes the one or more processors to:
generate, via the one or more processors, a prediction of the one or more friction events.

10. The system of claim 1, wherein the one or more friction events are identified in real-time.

11. A computer-implemented method to identify one or more friction events during an electronic journey of a customer of a business, the computer-implemented method comprising:
obtaining, via one or more processors, a plurality of electronic customer journey datasets,
wherein at least one of the plurality of electronic customer journey datasets,
corresponds to the electronic journey of the customer,
corresponds to a transaction between the customer and the business, and
indicates one or more transactional events associated with the transaction;
obtaining, via the one or more processors, friction identification rules used to identify the one or more friction events indicated in the at least one of the plurality of electronic customer journey datasets,
wherein a friction event is an event that negatively impacts completion of the transaction;
analyzing, via the one or more processors, the at least one of the plurality of electronic customer journey datasets using the friction identification rules;
responsive to identifying a friction event, generating, via the one or more processors, friction event information associated with the friction event;
providing, via the one or more processors, the friction event information to a fine-tuned large language model (LLM) configured to:
determine one or more topics associated with the friction event of the friction event information,
determine one or more sentiments of the customer associated with the friction event of friction event information, and
generate an indication, in the friction event information, of the one or more topics and/or the one or more sentiments; and
generate, via the one or more processors, at least one of:
(i) a user interface including the friction event information,
wherein the user interface is accessible via a computing device; or
(ii) an electronic alert based upon the friction event information.

12. The computer-implemented method of claim 11, wherein the at least one of the plurality of electronic customer journey datasets includes one or more of: customer feedback data, digital transaction event data, or customer communication data.

13. The computer-implemented method of claim 11, wherein the transaction includes one or more of: opening an account, a financial withdrawal, enrolling in a service, accessing account information, or receiving customer support.

14. The computer-implemented method of claim 11, wherein the friction identification rules are based upon business knowledge indicating transaction best practices.

15. The computer-implemented method of claim 11, wherein the friction event includes one or more of: a technical issue, a data processing issue, delay of a transactional event, or non-completion of a transactional event.

16. The computer-implemented method of claim 11, wherein the user interface includes one or more of: a graphical depiction of at least a portion of the friction event information, friction event analytics, or a recommendation associated with the friction event.

17. The computer-implemented method of claim 11, wherein the electronic alert indicates a suggested action to mitigate the corresponding friction event.

18. The computer-implemented method of claim 17, further comprising:
storing, via the one or more processors, the friction event information in a knowledgebase database accessible by the computing device.

19. The computer-implemented method of claim 11, where analyzing the at least one of the plurality of electronic customer journey datasets using the friction identification rules, further comprises:
generating, via the one or more processors, a prediction of the one or more friction events.

20. A non-transitory computer-readable medium storing processor-executable instructions that, when executed by one or more processors, cause the one or more processors to at least:
obtain a plurality of electronic customer journey datasets,
wherein at least one of the plurality of electronic customer journey datasets,
corresponds to an electronic journey of a customer of a business,
corresponds to a transaction between the customer and the business, and
indicates one or more transactional events associated with the transaction;
obtain friction identification rules used to identify one or more friction events indicated in the at least one of the plurality of electronic customer journey datasets,
wherein a friction event is an event that negatively impacts completion of the transaction;
analyze the at least one of the plurality of electronic customer journey datasets using the friction identification rules;
responsive to identifying a friction event, generate friction event information associated with the friction event;
provide the friction event information to a fine-tuned large language model (LLM), stored on one or more memories, and configured to:
determine one or more topics associated with the friction event of the friction event information,
determine one or more sentiments of the customer associated with the friction event of friction event information, and
generate an indication, in the friction event information, of the one or more topics and/or the one or more sentiments; and
generate at least one of:
(i) a user interface including the friction event information,
wherein the user interface is accessible via a computing device; or
(ii) an electronic alert based upon the friction event information.
